(19) United States
(12) Patent Application Publication
(10) Pub. No.: US 2025/0044525 A1
(43) Pub. Date: Feb. 6, 2025

(54) Inverted Rib Latch Design of a VSFF Fiber Optic Adapter

(71) Applicant: US Conec Ltd., Hickory, NC (US)

(72) Inventor: Jason Higley, Hickory, NC (US)

(21) Appl. No.: 18/927,726

(22) Filed: Oct. 25, 2024

Related U.S. Application Data
(63) Continuation-in-part of application No. 17/669,758, filed on Feb. 11, 2022.
(60) Provisional application No. 63/593,558, filed on Oct. 27, 2023.
(60) Provisional application No. 63/151,256, filed on Feb. 19, 2021.

(51) Int. Cl. G02B 6/38

(52) U.S. Cl. CPC G02B 6/3825

(57) ABSTRACT

A fiber optic adapter for mating fiber optic connectors includes an adapter body having an outer surface defined by a top wall and a bottom wall joined by opposite side walls, the adapter body having an inner cavity to receive at least a pair of fiber optic connectors from opposite ends thereof, and a cutout formed on the outer surface, the cutout has a solid base with a cutout surface; and a latch having a free end and an end joined to the adapter body, the latch movable into the cutout, wherein an underside of the latch has a non-uniform configuration

### REFERENCE TO RELATED CASE

This application claims priority under 35 U.S.C. § 119 (e) to U.S. provisional application No. 63/593,558 filed on Oct. 27, 2023 and is a continuation-in-part of U.S. patent application Ser. No. 17/669,758 filed on Feb. 11, 2022, the contents of these applications are hereby incorporated by reference in their entirety.

### BACKGROUND OF THE INVENTION

The typical integrated panel latch of a fiber optic adapter has a generally continuous surface parallel to the outer surface of the adapter body to which the latch is connected. Extending above the outer surface is a stiffening rib generally connected to a perpendicular wall that acts as the panel stop surface of the latch. The panel stop surface engages an adapter panel. These latch types typically include an opening that extends into the inner cavity of the adapter body. This opening results in a relatively robust manufacturing process (molding), however it leaves a significant path for debris in the system that is detrimental to performance. That is, debris can enter from the opening and travel inward in the adapter to where the fiber optic connectors mate.

Applicant has invented an adapter that has an integrated panel latch with a simplified molding preventing the intrusion of dust and debris and allows for much better performance than fiber optic adapters with openings around the latches.

### SUMMARY OF THE INVENTION

According to one aspect, the present invention is directed to a fiber optic adapter for mating fiber optic connectors therewithin, the fiber optic adapter includes an adapter body having an outer surface defined by a top wall and a bottom wall joined by opposite side walls, the adapter body having an inner cavity to receive at least a pair of fiber optic connectors from opposite ends thereof, an cutout formed on the outer surface, wherein the cutout has a solid base with a cutout surface, and a latch having a free end and an end joined to the adapter body, the latch movable into the cutout, wherein an underside of the latch has a non-uniform configuration.

In some embodiments, the underside has a projection or a rib extending into the cutout thereby creating the non-uniform configuration.

In some embodiments, the projection or the rib is between the free end and the end joined to the adapter body.

In some embodiments, the top wall lies in a first plane and the solid base lies in a second plane, the first plane and second plane being offset from each other.

In some embodiments, the second plane extends upward from a central portion of the adapter body toward an end of the adapter body.

In some embodiments, a distance from the middle portion to the side walls is about the same as a distance from the cutout surface to the underside of the latch.

In some embodiments, the cutout is formed on the outer surface at both the top wall and the bottom wall.

In some embodiments, the solid base is at an angle relative to the outer surface of the adapter body between the two opposite facing walls.

In some embodiments, an outward facing surface of the latch is at an angle relative to the outer surface of the adapter body.

In some embodiments the outer surface and the cutout surface are materially separated from the inner cavity.

In some embodiments, the adapter body and the latch are unitarily molded together.

In yet another aspect, there is a fiber-optic adapter for mating fiber optic connectors therewithin, the fiber optic that includes an adapter body having a top wall and a bottom wall joined by two side walls, the adapter body having an outer surface, a first side, a second side, and an inner cavity, the inner cavity defined by the top wall, bottom wall and side walls and extending between the first side and the second side to accept at least one fiber optic connector in each of the first side and the second side, an inner surface defined at least in part by the top wall, the bottom wall, and the side walls, the inner surface surrounding the inner cavity, the inner surface having a continuous separation from the outer surface by a material of the fiber optic adapter, at least two cutouts formed on the outer surface, wherein the at least two cutouts each have a solid base with a cutout surface, and at least two latches each having a free end and an end joined to the adapter body, the at least two latches movable into a respective one of the at least two cutouts, wherein an underside of each of the at least two latches has a non-uniform configuration.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of a prior art adapter with openings therein and a typical rib structure on the latches;

FIG. 2 is another perspective cross sectional view of the prior art adapter in

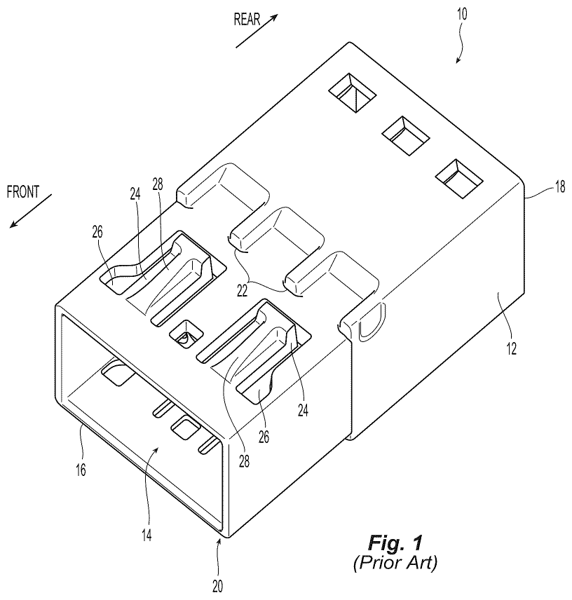

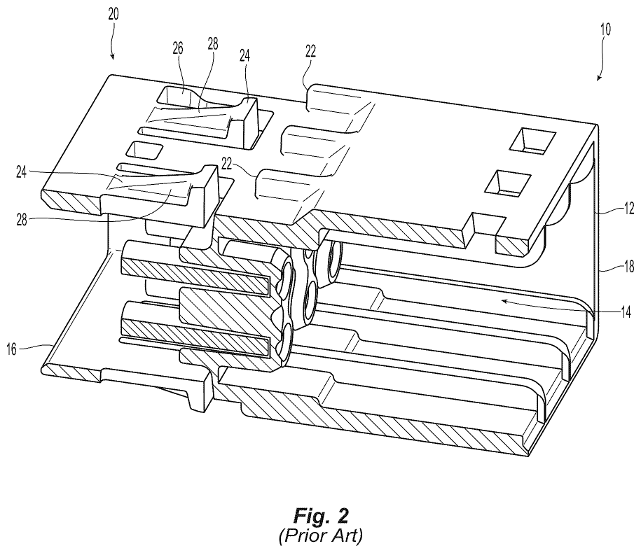

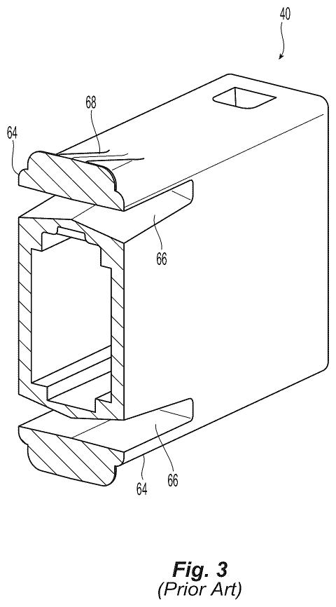

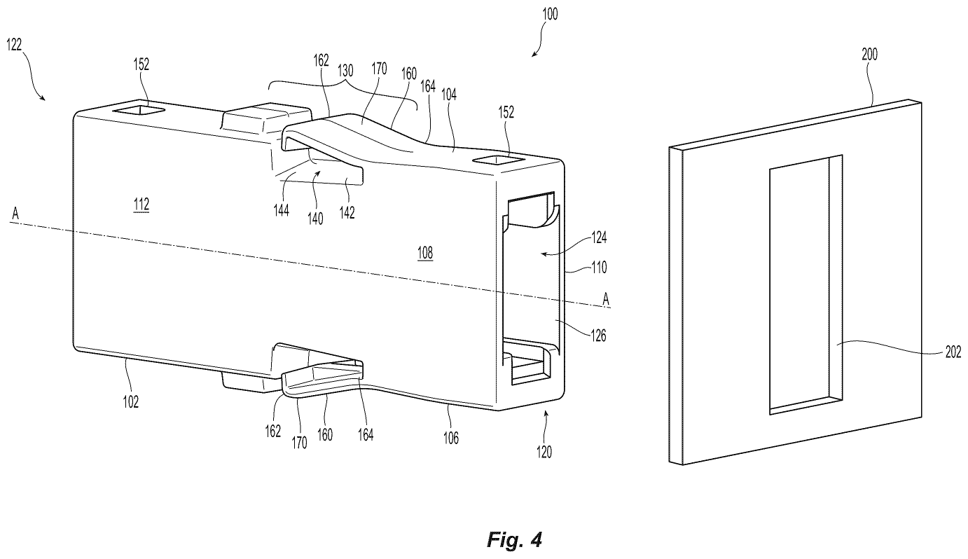

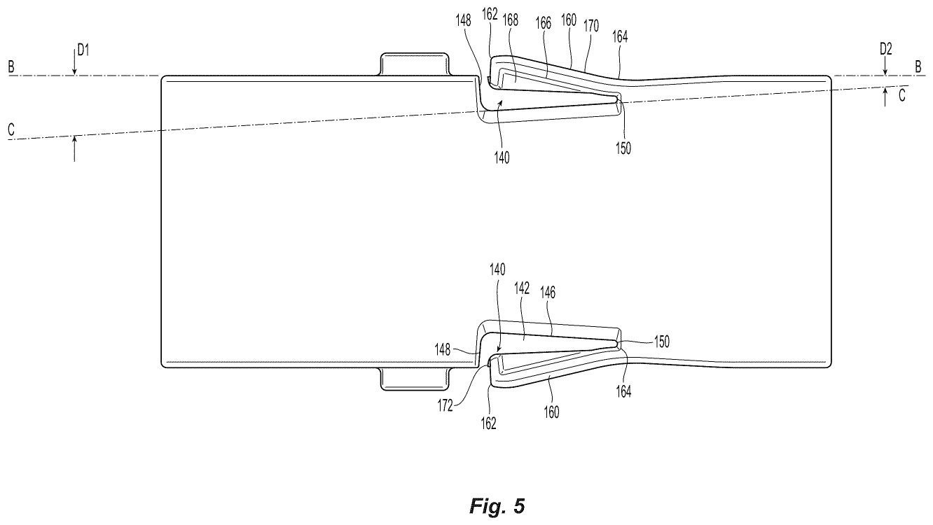

FIG. 1;

FIG. 3 is an enlarged view of a portion of a prior art single port adapter showing the typical rib structure;

FIG. 4 is a perspective view of one embodiment of an adapter according to the present invention and a portion of a panel into which the adapter is to be inserted;

FIG. 5 is a side elevational view of the adapter in FIG. 4;

FIG. 6 is an cross sectional view of a portion of the adapter in FIG. 4;

FIG. 7 is a partial side view of the adapter in FIG. 4 showing the opening between the adapter and the latch;

FIG. 8 is a cross sectional view of the adapter in FIG. 3 showing the forming tools making the opening between the prior art adapter and the latch;

FIG. 9 is cross sectional view of the adapter in FIG. 4 showing the forming tools making the opening between the adapter and the latch; and

FIG. 10 is a partial cross sectional side view of the adapter in FIG. 4 showing details of the opening.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

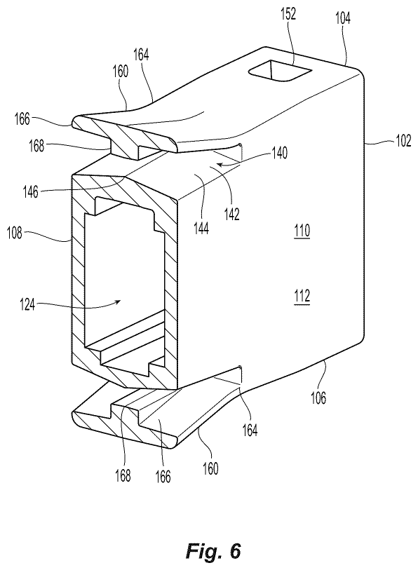

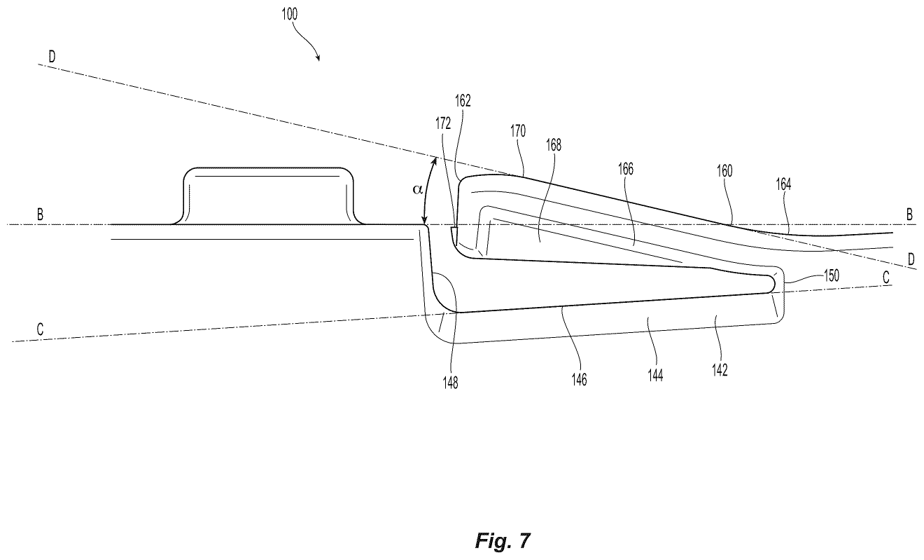

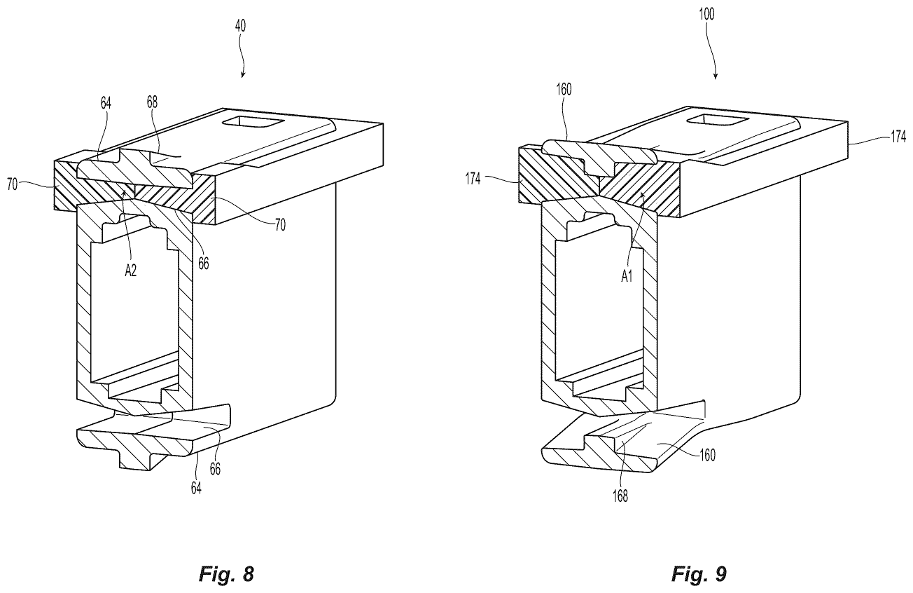

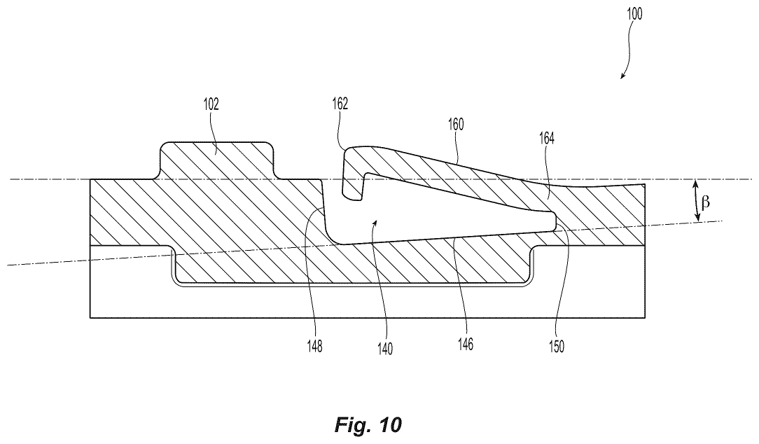

Illustrated in FIGS. 1 and 2 is a prior art adapter 10. The adapter 10 has a main body 12 and a central opening 14 to receive fiber optic connectors (not shown) in opposing ends 16,18. To connect the adapter 10 to an adapter panel, the front end 20 of the adapter 10 is inserted in to an opening in the adapter panel. The adapter 10 is pushed into the adapter panel until the forward facing surfaces 22 make contact with the adapter panel. There are two latches 24 that prevent the adapter 10 from being unintentionally removed from the adapter panel. As the adapter 10 is inserted into the opening, the latches 24 are pushed downward into the latch openings 26. The latches 24 have a rib 28 on an outside portion of the latch 24. As can be seen in FIG. 2, the latch openings 26 penetrate all the way through the main body 12 allowing dirt and debris to enter therethrough. It should also be noted that the fiber optic connectors that are inserted into each side of the main body 12 are mated in close proximity to the latch openings. There are latches 24, latch openings 26 and forwarding facing surfaces 22 on two sides of the adapter 10. Cf. FIG. 1 and FIG. 2.

A portion of another prior art adapter 40 is illustrated in FIG. 3. This adapter 40 also has two latches 64, one on each side of the adapter 40. The latches 64 also have a rib 68 on the outside portion of the latches 64. Thus, the outside portion of the latches 64 is not of a uniform configuration. This causes the area 66 between the latch 64 and the body of the adapter 40 to be smaller than in the present invention. See, e.g., FIGS. 6-8. Further, the underside of the latches 64 in the area 66 has a uniform or smooth configuration.

Applicant notes that the term “front” or “forward” means that direction where the adapter would be inserted into an adapter panel, while the term “rear” or “rearward” is used to mean the opposite direction. In the present application, the adapter 100 will therefore have a front and a rear, the front will be inserted into the panel first. Thus, in FIG. 4, the “front” of the adapter 100 is on the right side of the figure and pointing out of the figure. The “rear” or “back” is that part of the adapter 100 that is on the left side of the page and “rearward” and “backward” is toward the left and into the page.

Turning now to FIGS. 4-6, there is one embodiment of a fiber optic adapter 100 for mating fiber optic connectors therewithin and being inserted into a panel 200 with an opening 202 to receive the adapter 100. See FIG. 4. The adapter 100 has a main body 102 with a top wall 104 and a bottom wall 106 joined to each other by a pair of oppositely disposed side walls 108,110. These walls 108,110 provide the main body 102 with an outer or outside surface 112. The adapter 100 is preferably molded as a unitary piece from the same material and in a single mold, but could be assembled from a plurality of pieces that are either the same or different materials. Thus, the recitation of the walls 108, 110 is merely to describe the structures and not to be limiting by requiring that the walls 108,110 be separate elements.

The adapter 100 has a first side 120 and a second side 122 longitudinally opposite the first side 120, the first side 120 and the second side 122 are configured to receive at least one fiber optic connector for mating along the longitudinal axis A in a main opening 124. One fiber optic connector (not shown) can be inserted on each of the first side 120 and the second side 122. However, the adapter may be made larger so as to accept more than one fiber optic connector on each side, i.e., 2, 4, 8, or 12 fiber optic connectors and still fall within the scope of the present invention. The main opening 124 is, at least in part, defined by the top wall 104, the bottom wall 106 and the side walls 108, 110, and extends between the first side 120 and the second side 122 to accept the fiber optic connectors for mating. The adapter 100 may have a footprint conforming to one or more industry standards or per industry multi-source agreements (e.g., QSFP). Accordingly, the fiber optic connectors received by the adapter 100 may be in the Very Small Form Factor (VSFF) format, e.g., the MDC connector provided by the Applicant.

The main body 102 has an inner surface 126 defined at least in part by the top wall 104, the bottom wall 106 and the side walls 108,110, the inner surface 126 surrounding and defining at least a portion of the main opening 124. The main opening 124 is interchangeably referred to herein as an inner cavity of the adapter 100. The main opening 124 has a fiber optic connector mating space 130 for the mating of the fiber optic connectors inserted from each of the first side 120 and second side 122. The mating space 130 is generally in a central portion inside the main body 102 of the adapter 100. It should be noted that the mating space 130 may be disposed at other locations along the length of the adapter 100. The inner surface 126, and thus the inner cavity, has a continuous separation from the outside surface 112 at least around the fiber-optic connector mating space 130 by a material (or more than one material) of the fiber optic adapter 100. See FIGS. 5, 8, and 10. Preferably, the inner surface 126 is fully separated from the outside surface 112 by the material of the adapter. There may be fiber optic connector latch openings 152 near the front and rear ends of the adapter 100, but those fiber optic connector latch openings 152 are sufficiently far away from the connector mating space 130 to contribute any substantial dust or debris.

The adapter 100 has at least one cutout 140 formed on the outside surface 112, wherein the cutout 140 has a solid base 142 with a cutout surface 144. The cutout 140 may have a flat cutout surface 144 or it may have a pitch to it as illustrated in FIG. 6. Thus, in this embodiment, the solid base 142 is sloped from a middle portion 146 to the side walls 108,110. Preferably, the adapter 100 has two cutouts 140 on opposite sides of the main opening 124, one in each of the top wall 104 and the bottom wall 106. The cutouts 140 are preferably the same on each side of the adapter 100. The cutout surfaces 144 are bound in the longitudinal direction (axis A) by two opposite facing walls 148,150.

Included with each of the cutouts 140 is a latch 160 for the engaging the panel 200. As shown in the figures, the adapter 100 preferably has two latches 160, one with each cutout 140. The latches 160 have a free end 162 adjacent the first opposite facing wall 148 and a second end 164 joined to the adapter body 102 at the second opposite facing wall 150. As can be realized from FIGS. 4, 5 and 7, the latches 160 can be rotated about the second end 164 and into the cutout 140. This allows for the adapter 100 to be removed from the panel 200 (or any other structure). The latches 160 also have a non-uniform configuration on an underside 166 thereof, and in this case that is a rib 168 (or, a projection 168) that extends from the free end 162 toward the second end 164. It is understood that the rib 168 could have other configurations and still fall within the scope of the present invention. For example, the rib 168 may not be a continuous structure, and/or may have a varying width or thickness). The top surface 170 of the latches 160 are preferably smooth, as seen in FIGS. 4 and 10. It should also be noted that the adapter body 102 and the latches 160 are molded together as a unitary piece.

Turning now to FIGS. 5 and 7, the top wall 104 lies in a first plane B and the solid base 142 (at the middle portion 146) lies in a second plane C. The planes B and C have a first distance D1 between them at the second side 122 and a second distance D2 at the first side 120, with D1 being greater than D2. It should also be noted that the solid base 146 extends upward from the second side 122 toward the first side 120. See FIG. 7. The top surface 170 of the latches 160 is at an angle relative to the outer surface 112 of the top wall 104. See angle α made by planes B and D in FIG. 7.

The free end 162 has a projection or knob 172 that projects out from the free end 162 toward the first opposing facing wall 148. The projection 172 engages the panel 200 when the adapter 100 is inserted thereinto. This helps to keep the adapter from rattling around in the opening 202 of the panel 200 and greatly reduces the bending stresses and increases the latch retention strength. While the projection 172 is relatively small and pointed, it can take almost any shape and still perform its function. The projection 172 is preferably at or below the outside surface 112 of the top wall 104 when there is no pressure or force on the latch 160. This prevents the projection 172 from snagging any other structure. See FIG. 7.

Referring to FIGS. 5 and 10, the solid base 142 is formed at an angle β relative to the top wall 104 (and even the bottom wall 106). This allows for the full range of motion of the latch 160 as the cutout 140 having a certain depth is needed at the free end 162 of the latch 160. In order to allow for this cutout 140 depth while also ensuring the most material is added for structural integrity, the cutout 140 is angled towards the outer surface as it gets closer to the second end 164 of the latch 160. By having a thicker section of material at the second end 164, the chance of critical failure due to bending stresses is greatly decreased, leading to a more robust latch 160. Without the angle β, the cutout 140 would lead to a section of extremely thin material at the second end 164, increasing the chance of failure drastically. There would also be a chance of material failing to fill the section, leading to the main opening 124 being exposed. The angle β may be 3°-5°, although it is more of a space determined number including how far the latch 160 must depress, the length of the latch 160 and the material thickness of the latch 160.

Turning now to FIGS. 8 and 9, these figures that illustrate the advantage of the rib 168 being on the underside of the latch 160 rather than being on top of the conventional latch 64. FIG. 8 shows the prior art adapter 40 with the manufacturing tooling or molding steel 70 and FIG. 9 shows the adapter 100 and the manufacturing tooling or molding steel 174. With the rib 168 being in the cutout 140, the molding steel 174 can be thicker from the side walls 108,110 toward the middle portion 146 of the cutout 140. See arrow A1 in FIG. 9 and arrow A2 in FIG. 8. This is important because the increased thickness of the molding steel 174 in FIG. 9 relative to the molding steel 70 reduces the possibility that the molding steel will break from being too long and too thin. The new configuration allows for a distance from the middle portion 146 to the side walls 108,110 to be about the same as a distance from the cutout surface 144 to the underside of the latch 160. Thus, the non-uniform configuration of the underside of the latch 160 has molding advantages (more robust mold that is less prone to breakage). The rib 168 is thus in an inverted configuration when compared with the conventional rib 68 of the conventional latch 64.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A fiber optic adapter for mating fiber optic connectors therewithin, the fiber optic adapter comprising:
an adapter body having an outer surface defined by a top wall and a bottom wall joined by opposite side walls, the adapter body having an inner cavity to receive at least a pair of fiber optic connectors from opposite ends thereof;
a cutout formed on the outer surface, wherein the cutout has a solid base with a cutout surface; and
a latch having a free end and an end joined to the adapter body, the latch movable into the cutout, wherein an underside of the latch has a non-uniform configuration.

2. The fiber optic adapter of claim 1, wherein the underside has a projection or a rib extending into the cutout thereby creating the non-uniform configuration.

3. The fiber optic adapter of claim 2, wherein the projection or the rib is between the free end and the end joined to the adapter body.

4. The fiber-optic adapter of claim 1, wherein an outward facing surface of the latch is smooth.

5. The fiber-optic adapter of claim 1, wherein the top wall lies in a first plane and the solid base lies in a second plane, the first plane and second plane being offset from each other.

6. The fiber-optic adapter according to claim 5, wherein the second plane extends upward from a central portion of the adapter body to an end of the adapter body.

7. The fiber-optic adapter of claim 1, wherein the solid base of the adapter body is sloped on each side of a middle portion to the side walls.

8. The fiber-optic adapter according to claim 7, wherein a distance from the middle portion to the side walls is about the same as a distance from the cutout surface to the underside of the latch.

9. The fiber-optic adapter according to claim 1, further comprising a projection from the free end of the latch to engage a panel.

10. The fiber-optic adapter according to claim 1, wherein the cutout is formed on the outer surface at both the top wall and the bottom wall.

11. The fiber-optic adapter according to claim 1, wherein the cutout surface is bound in a longitudinal direction by two opposite facing walls of the cutout.

12. The fiber-optic adapter according to claim 11, wherein the free end of the latch is between the two opposite facing walls in the longitudinal direction.

13. The fiber-optic adapter according to claim 11, wherein the solid base is at an angle relative to the outer surface of the adapter body between the two opposite facing walls.

14. The fiber-optic adapter according to claim 1, wherein an outward facing surface of the latch is at an angle relative to the outer surface of the adapter body.

15. The fiber-optic adapter according to claim 1, wherein the outer surface and the cutout surface are materially separated from the inner cavity.

16. The fiber-optic adapter according to claim 1, wherein the adapter body and the latch are unitarily molded together.

17. A fiber-optic adapter for mating fiber optic connectors therewithin, the fiber optic adapter comprising:
an adapter body having a top wall and a bottom wall joined by two side walls, the adapter body having an outer surface;
a first side, a second side, and an inner cavity, the inner cavity defined by the top wall, bottom wall and side walls and extending between the first side and the second side to accept at least one fiber optic connector in each of the first side and the second side;
an inner surface defined at least in part by the top wall, the bottom wall, and the side walls, the inner surface surrounding the inner cavity, the inner surface having a continuous separation from the outer surface by a material of the fiber optic adapter;
at least two cutouts formed on the outer surface, wherein the at least two cutouts each have a solid base with a cutout surface; and
at least two latches each having a free end and an end joined to the adapter body, the at least two latches movable into a respective one of the at least two cutouts, wherein an underside of each of the at least two latches has a non-uniform configuration.

18. The fiber-optic adapter according to claim 17, wherein one of the at least two cutouts is formed on each of the outer surface at both the top wall and the bottom wall.

19. The fiber-optic adapter according to claim 17, wherein the underside of each of the at least two latches has a projection or a rib extending into respective ones of the at least two cutouts thereby creating the non-uniform configuration.

20. The fiber-optic adapter according to claim 17, wherein an outward facing surface of each of the at least two latches is smooth.
